(19) United States
(12) Patent Application Publication
(10) Pub. No.: US 2001/0032074 A1
(43) Pub. Date: Oct. 18, 2001

(54) Transaction processing system with voice recognition and verification

(76) Inventors: Vance Harris, Dublin (IE); Patrick Peter Keaney, Dublin (IE)

Correspondence Address: JACOBSON, PRICE, HOLMAN & STERN, PROFESSIONAL LIMITED LIABILITY COMPANY, 400 SEVENTH STREET N.W., WASHINGTON, DC, 20004, US

(21) Appl. No.: 09/855,510

(22) Filed: May 16, 2001

Related U.S. Application Data
(63) Continuation of application No. PCT/IE99/00110, filed on Nov. 5, 1999.

(30) Foreign Application Priority Data
Nov. 16, 1998 (IE) 980941

(51) Int. Cl. G10L 15/00

(52) U.S. Cl. 704/231

(57) ABSTRACT

A transaction processing system (1) has a central hub (2) which interconnects a high-speed database server (3), a voice processing server (5), and an interface server (6). The voice processing server (5) has a central processor and distributed processors including telephony interface circuits (5a), station interface circuits (5b), speech recognition DSPs (5c), and text-to-speech circuits (5d). The server (5) distributes processing in such a way that a user can make a telephone call to the system and convey data for a transaction by normal speech. The system uses this data to generate transaction records and the process transactions.

The invention relates to a transaction processing system.

One of the problems in management of business at present is that of processing relatively small transactions in an efficient manner. Such processing tends to add a proportionally high overhead to a business, and in many cases it is not done correctly.

The invention is therefore directed towards providing a transaction processing system which allows relatively small transactions to be handled efficiently.

According to the invention, there is provided a transaction processing system comprising:

central processor connected to telephony interface circuits, to a speech recognition circuit, and to a text-to-speech circuit;

a high speed database server;

a voice verification sub-system;

means in the central processor to:

control the telephony interface circuit and the text-to-speech circuit to receive user speech,

control the speech recognition circuit to recognise a user code in the user's speech,

direct user verification by the voice verification sub-system with reference to a stored user voice model,

generate a transaction record in the database server and initiate a transaction if user verification is positive, and

transmit user transaction data to a remote system via the telephony circuit.

The system therefore allows transactions to be initiated by the user simply making a call to the system and transmitting transaction information by normal speech. The system automatically performs user verification, generates a transaction record, and transmits transaction data to a client remote site. Thus, the system allows provision of comprehensive transaction processing services without the need for users to be specially trained. All they need to do is to dial a particular telephone number and speak the information which is required.

In one embodiment, the central processor comprises means for directing recordal of a user's speech, and analysis of the speech to generate transaction data for the transaction record. This allows recordal of the speech which initiates the transaction for subsequent validation, and it also allows comprehensive transaction processing.

In one embodiment, the speech record is stored locally at the central processor and the central processor establishes a relationship between the speech record and an associated transaction record on the database server.

Preferably, the central processor comprises means for retrieving multiple transaction records from the database server and batch processing the transaction records to generate client transaction reports.

In one embodiment, the system further comprises an interface server connected to the central processor and to the database server, and comprising means for providing supervisor access to data and speech records, and for compiling the records to generate reports.

Preferably, the system comprises a hub, and the database server, the central processor and the interface server are connected to each other via the hub.

In another embodiment, the voice verification sub-system is connected to the hub.

In another embodiment, the interface server is connected directly to a backup system, and the interface server comprises means for directing retrieval of transaction records from the database server and speech records from the central processor to back up data.

Preferably, the hub comprises wide area network interface circuits for administration terminals.

In another embodiment, the central processor comprises means for inserting a flag in a sub-set of the speech records generated, and means for subsequently retrieving flagged speech records for quality control.

Preferably, the voice verification sub-system comprises a frequency domain voice model to represent user vocal tract characteristics.

In one embodiment, the central controller comprises means for determining a dialled number segment and a dialling number and for determining according to logic a likely required service, and for automatically generating and transmitting a service-specific greeting requesting a user spoken code.

In another embodiment, the central controller comprises means for performing user spoken code recognition to generate a list of possible candidate codes, and for attempting to retrieve a client database record addressed by each code in turn until successful.

In one embodiment, the central controller comprises means for sorting the candidate codes into descending probability order, and for processing the codes in that order.

Preferably, the central controller comprises means for validating a code for which there is a client record by performing voice verification.

In one embodiment, the voice verification is performed using the spoken code which is recognised.

Preferably, the system comprises a client-specific stored verification score threshold, above which verification is positive and below which verification is negative.

In one embodiment, said threshold is set by processing parameter values for a cost of a false accept, a cost of a false accept, and an impostor factor.

In one embodiment, the controller comprises means for dynamically adjusting the impostor factor according to false accept event data.

In a further embodiment, the central controller comprises means for re-attempting by requesting a fresh spoken code to perform recognition and verification again if the candidate code list is exhausted without identification of a valid client record.

In one embodiment, the central controller comprises means for re-attempting only a limited number of times.

The invention will be more clearly understood from the following description of some embodiments thereof, given by way of example only with reference to the accompanying drawings in which:

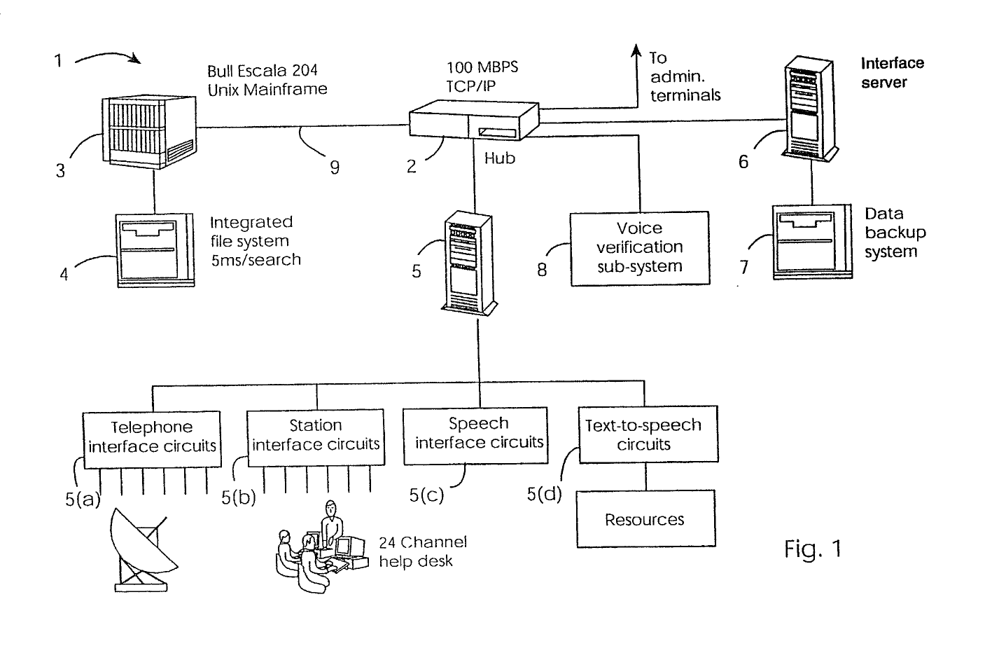

FIG. 1 is a diagram illustrating a transaction processing system of the invention;

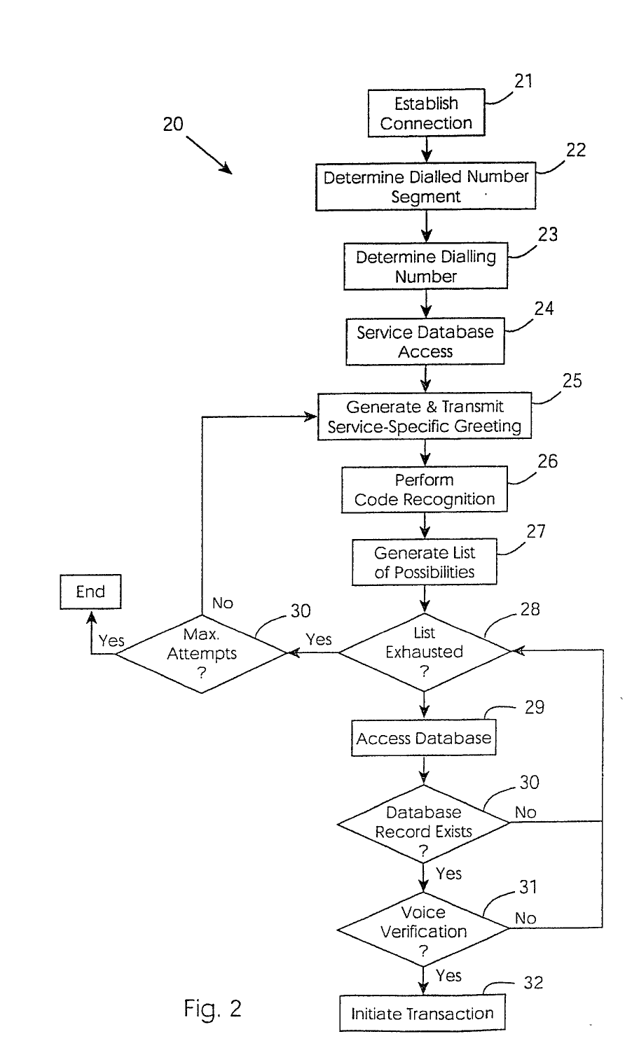

FIG. 2(a) and 2(b) are together a is a flow chart illustrating operation of a system;

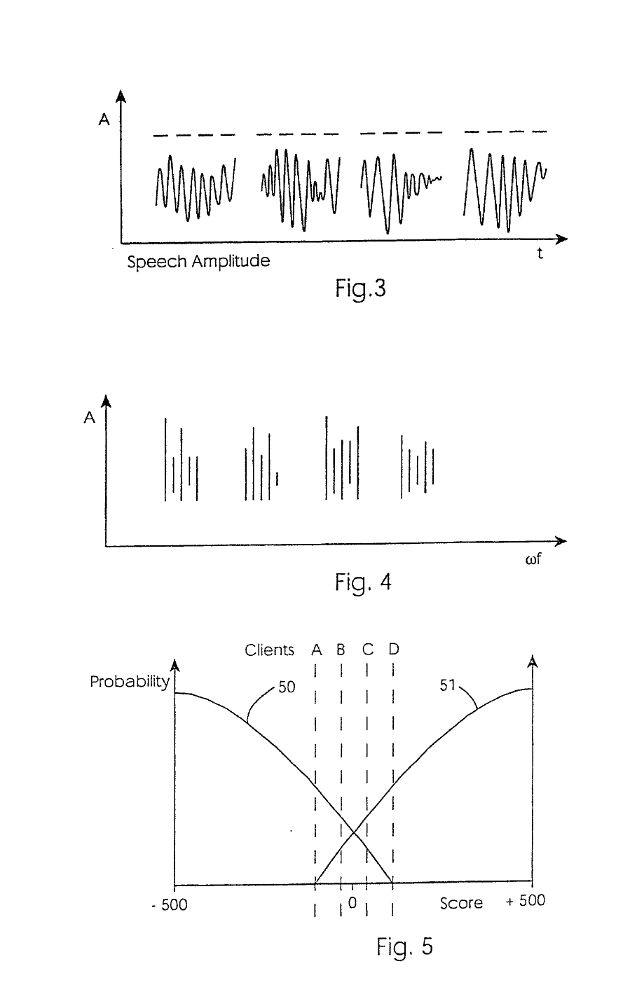

FIGS. 3, 4, and 5 are plots showing voice verification parameters; and

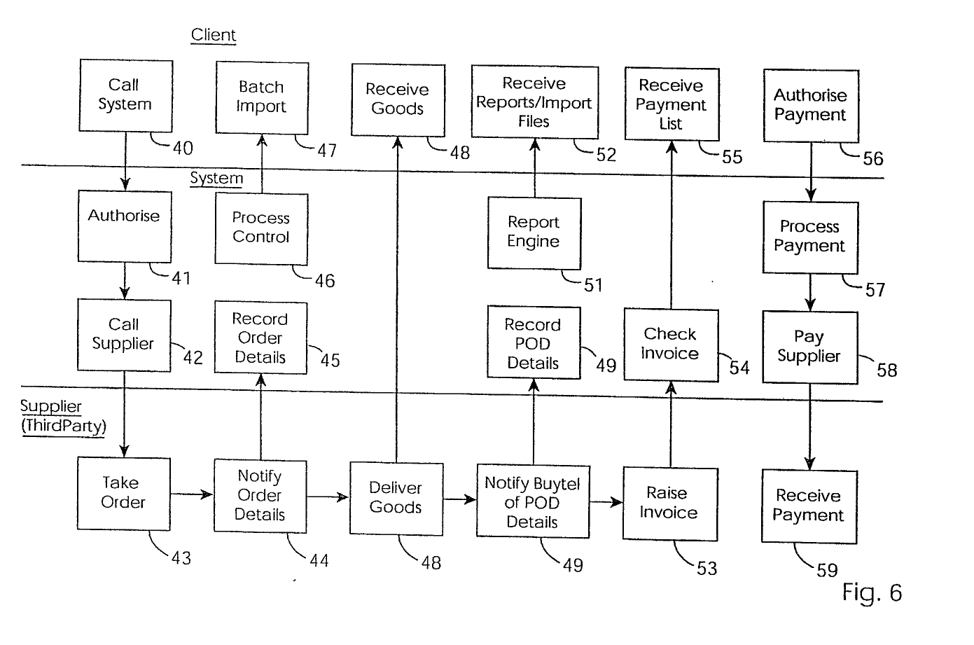

FIG. 6 is a flow diagram illustrating transaction processing.

Referring to the drawings, and initially to FIG. 1 there is shown a transaction processing system 1 of the invention.

The system 1 comprises a 100 Mbit/s hub 2 which controls TCP/IP communication between circuits within the system 1. It also comprises wide area network interface circuits for administration terminals. These terminals are used by staff in providing transaction processing services using the system 1.

The hub 2 is connected by 100 Mbit/s UTP cable to a Bull Escala 204™ Unix mainframe symmetrical multi-processing system 3. This provides high speed access to an Integrated File System (IFS) database 4 which stores user and transaction records. The file search time is approximately 5 ms and this time is stable because it is independent of the database size. There may be many millions of records in the database.

The system 1 also comprises a central controller 5 connected to the hub 2. The controller 5 comprises a central processor and distributed processors 5(a) to 5(d) connected to it by an internal system bus. The distributed processors are described in more detail below.

An NT™ interface server 6 is also connected to the hub 2, and is also directly connected to a data backup system 7. The interface server 6 is programmed to operate as a supervisor interface to the mainframe 3 and the central controller 5. It also operates to back up files on these devices. An important aspect of the interface server 6 is that it provides a central GUI interface to the storage structures of the mainframe 3 and the IFS 4 and the central controllers 5.

Referring again to the central controller 5, this comprises a set of ISDN digital telephony interface circuits 5(a). These circuits include Calling Line Identification (CLI) circuits to determine the source of a telephony connection. Station interface circuits 5(b) allow connection of users to a help desk. The connection is via a TDM bus. Speech recognition DSPs 5(c) are programmed for speech recognition of multiple languages. Finally, the controller 5 comprises a text to speech telephony circuit 5(d) with associated resources.

The system 1 also comprises a voice verification sub-system 8 connected directly to the hub 2. The sub-system 8 comprises a processor programmed with user voice models to verify users who call via the ISDN telephony circuits 5(a).

Referring now to FIG. 2, operation of the system 1 is now described as a method 20. This method involves a user connecting with the system 1, being verified, and a transaction being performed. The system is suited to processing large volumes of transactions, thus removing a major administration workload from clients.

In step 21 a user of a client establishes a telephony connection at a station interface circuit 5(a). The call may be temporarily routed to a station interface circuit 5(b) if assistance is required.

The interface circuit 5(a) in steps 22 and 23 determines and uploads to the central controller the identity of a relevant segment of the dialled number, together with the user dialling number. The central controller 5 then in step 24 used these to address client/service databases in the file system 4. The database addressing is performed using fuzzy logic code to determine a likely required service for the client. For example, “freephone” dialled number segment 9500 may relate to a tele-purchasing service, while 9400 may relate to a time clock service. Regarding the user dialling number, the client database record may indicate that the client has subscribed to only one service. This information is used by the fuzzy logic code to decide on the most likely required service. In step 25 the text-to-speech circuits 5(d) generate an appropriate service-specific greeting using the service information. This helps to dramatically reduce the processing time per call, which is very significant for a system handling very large call volumes.

The greeting transmitted in step 25 requested the user to speak a code, typically their client code. The control controller 5 is programmed with a code recognition engine to recognise the code in step 26, in this embodiment the client account number. An important aspect of the code recognition is that in step 27, the central controller 5 generates a list of five possible numbers such as 10114, 10194, 10195, 12194, and 10111. Confidence factors are used to prioritise the list in descending confidence factor order.

In step 29 the controller 5 accesses a client database with the first code in the list (the list not being exhausted as indicated in decision step 28). As indicated by a decision step 30, if a record exists the controller 5 immediately activates the voice verification. If no record for the code exists the controller 5 repeats for each code on the list until either a record is addressed or the list is exhausted (step 28). If the list is exhausted, the controller 5 returns to step 25 unless the maximum number of allowed attempts has been used, as indicated by the decision step 30.

The voice verification step uses a voice model which describes the user's vocal tract on the basis of sound parameters with conversion from the time domain illustrated in FIG. 3 to the frequency domain as illustrated in FIG. 4. FIG. 3 shows the amplitudes of four speech bursts, each one being a numeral. FIG. 4 shows a set of corresponding signatures for the speech bursts in the frequency domain. Verification is performed with the spoken code which has been recognised.

Referring to FIG. 5, probability curves for scores are shown. The plot 50 is for probability of false rejects and the plot 51 is for probability of false accepts. The central controller 5 is initialised on a client-by-client basis by determining an equal error rate (EER). This is a score level on the plot of FIG. 5. Four levels A, B, C, and D are shown by interrupted lined for four different clients. The EER value is determined by processing the following parameter values:

CFA: Cost of False Accept (e.g. £7,000 for a credit card fraud)

CFR: Cost of False Reject (e.g. 0.20 p for processing time lost);

I: Impostor factor (e.g. 1:10,000 likelihood of an impostor).

The opposing costs are used with the Impostor Factor to determine an EER-related value which is the threshold position on the probability scale of FIG. 5.

A major benefit of this initialisation is that the controller and the sub-system 8 can immediately determine whether verification is positive or negative. It simply determines a score according to comparison with the voice model associated with the located client record. It then determines if the score is higher or lower than the threshold for that client.

If verification is positive the controller initiates a transaction in step 32, an example being described below with reference to FIG. 6.

An important aspect of recognition and verification in the system 1 is that verification is brought into the recognition loop to assist and it avoids the need for further interactive communication with the user before the transaction. It has been found that it is possible to achieve an average time for steps 21 to 32 of approximately 0.5 sec and an accuracy of 99.87 has been achieved. The high accuracy is achieved because the client threshold is set using dynamic feedback of false accept events to change the Impostor Factor I and so dynamically re-calculate the client threshold. Accuracy is also assisted by randomly generating digit pairs for the user to speak to avoid problems caused by unauthorised users making recordings and playing back.

To initiate a transaction (step 32), the central processor directs the mainframe 3 to create a transaction record on the IFS 4. A variety of different transactions may be performed.

For example, the transaction may be processing of an order for goods such as stationery. A supplier processes the order and the system 1 receives updates of transaction progress and automatically updates the transaction record. The system 1 also automatically generates client reports indicating progress of a transaction. These reports draw from multiple transaction records for a single client so that the data is consolidated.

For three-way transactions, the central processor automatically links the user to a third party, such as a goods supplier. They have a discussion, and all speech is recorded. Again, the speech generates data in the system. This is subsequently used for tracking the records of the third party and verifying their data.

In more detail, and referring specifically to FIG. 6, the system 1 is called by the user in step 40. The user code is recognised and the user verified in step 41, upon which the telephony interface circuit 5(a) calls the system of a goods supplier in step 2. The supplier is identified from the user record. There is then a voice discussion in step 43 in which the supplier takes the order, and the order details are notified in step 44. The supplier system transmits the order details to the system 1 upon which the central processor directs updating of the transaction record via the mainframe 3 and the IFS 4. The central processor carries out process control (step 46) by automatically updating the transaction record as data is received. Batch reports are generated in step 47. Typically, these are initiated by the interface server 6.

The goods are delivered in step 48, upon which the supplier system is updated in step 49 and, in turn, the system 1 is updated in step 50. A report engine in the interface server 6 in step 51 generates a transaction report, which is received in step 52. When the supplier raises an invoice (step 53), this is validated in step 54 and a payment list is transmitted to the client in step 55. The client system authorises the payment in step 56 and it is processed by the system 1 in step 57. The supplier is paid in steps 58 and 59.

It will be appreciated that the system 1 operates in parallel to that of the supplier, allowing tracking of progress and also generation of management reports for the client. Therefore, the system is again performing important administration for the client—a very useful service, particularly for supply of small items such as stationery for an office. It will be appreciated that the system 1 operates in parallel to that of the supplier, allowing tracking of progress and also generation of management reports for the client. Therefore, the system is again performing important administration for the client.

An important feature of the system 1 is that it has the capability to record the user's speech. This forms the basis of many types of transactions. In a two-way transaction, the speech is processed to generate transaction data. This may be automatic, manual, or a combination. For example, for manual processing a staff member listens and inputs data very quickly using a pointing device to select displayed options. An example is apportioning time of the user to different jobs for time recording. In this case a GUI allows very quick linking of time to jobs without the need to use a keyboard. The speech is stored in a speech record on the controller 5, which is cross-referenced to the transaction record on the IFS 4. The speech is stored as an ALAW algorithm encoded, silence compressed sound file in 8 bit and 8 kHz format.

In another transaction example, the central processor directs the interface circuits 5(a) to identify the source of the connection. It uses this information together with a time stamp for the call to generate a transaction. In this example there is no speech recording and the system simply records time stamps for clients users “clocking in” and “clocking out” of work. The central processor may use data in a previously-generated transaction record or the user record to generate speech transmitted to the user. An example is to inform the user that he or she did not “clock out” the previous day. The data in the transaction records for this service may be uploaded to a client's system for processing at their end.

For quality control, the central processor inserts a flag in transaction records at regular intervals, such as every 20 records. The flags are used by a supervisor to retrieve these records and to check that the data is correct according to the recorded speech.

The interface server 6 operates to interrogate the transaction record on the IFS 4 and the corresponding speech records on the controller 5. It thus acts as a central data retrieval and processing node which has equal access to data and speech records. This is very important for generation of reports for clients which include data relating to many users. For example, monthly time recording reports may be provided. The server 6 also controls backup of data using the backup system 7. Again, it does this by retrieving data from both the IFS 4 and the voice-processing server 5. It has been found that by distributing the processing across the various processors of the voice central controller 5, the mainframe 3 and the IFS 4, and the interface server 6, the system 1 has a very large processing capacity. Indeed, it has been found that many millions of transaction records in the IFS 4 may be handled without any appreciable delay in response time. The central processor of the voice-processing server 5 acts to co-ordinate the distributed processing in a very effective manner in conjunction with the mainframe 3.

It has been found that by recording speech to activate transactions, a comprehensive range of types of transactions may be processed. The system 1 allows a service to be provided to clients whereby users (typically employees of the client) do not need to familiarise themselves with any new technology or procedures. It is only necessary that they dial a particular number and speak in the normal manner to initiate a transaction. In this way, a huge administration overhead is taken off the clients and therefore, the system 1 may be used to provide a very valuable service. Also, because voice is stored, integrity of the data can be ensured because a record is available. Of course, the quality control check using the flags to retrieve records also helps to ensure integrity. Another advantage of the system 1 is the manner in which users are verified, which allows a large degree of flexibility. The procedure ranges from immediate activation of transactions to comprehensive “digit pair” voice verification before access is allowed.

The invention is not limited to the embodiments described, but may be varied in construction and detail within the scope of the claims

1. A transaction processing system comprising:
a central processor connected to telephony interface circuits, to a speech recognition circuit, and to a text-to-speech circuit;
a high speed database server;
a voice verification sub-system;
means in the central processor to:
control the telephony interface circuit and the text-to-speech circuit to receive user speech,
control the speech recognition circuit to recognise a user code in the user's speech,
direct user verification by the voice verification sub-system with reference to a stored user voice model,
generate a transaction record in the database server and initiate a transaction if user verification is positive, and
transmit user transaction data to a remote system via the telephony circuit.

2. A system as claimed in claim 1, wherein the central processor comprises means for directing recordal of a user's speech, and analysis of the speech to generate transaction data for the transaction record.

3. A system as claimed in claim 2, wherein the speech record is stored locally at the central processor and the central processor establishes a relationship between the speech record and an associated transaction record on the database server.

4. A system as claimed in claim 1, wherein the central processor comprises means for retrieving multiple transaction records from the database server and batch processing the transaction records to generate client transaction reports.

5. A system as claimed in claim 4, further comprising an interface server connected to the central processor and to the database server, and comprising means for providing supervisor access to data and speech records, and for compiling records to generate reports.

6. A system as claimed in claim 5, wherein the system comprises a hub, and the database server, the central processor and the interface server are connected to each other via the hub.

7. A system as claimed in claim 6, wherein the voice verification sub-system is connected to the hub.

8. A system as claimed in claim 6, wherein the interface server is connected directly to a backup system, and the interface server comprises means for directing retrieval of transaction records from the database server and speech records from the central processor to back up data.

9. A system as claimed in claim 6, wherein the hub comprises wide area network interface circuits for administration terminals.

10. A system as claimed in claim 3, wherein the central processor comprises means for inserting a flag in a sub-set of the speech records generated, and means for subsequently retrieving flagged speech records for quality control.

11. A system as claimed in claim 1, wherein the voice verification sub-system comprises a frequency domain voice model to represent user vocal tract characteristics.

12. A system as claimed in claim 11, wherein the central controller comprises means for determining a dialled number segment and a dialling number and for determining according to logic a likely required service, and for automatically generating and transmitting a service-specific greeting requesting a user spoken code.

13. A system as claimed in claim 11, wherein the central controller comprises means for performing user spoken code recognition to generate a list of possible candidate codes, and for attempting to retrieve a client database record addressed by each code in turn until successful.

14. A system as claimed in claim 13, wherein the central controller comprises means for sorting the candidate codes into descending probability order, and for processing the codes in that order.

15. A system as claimed in claim 13, wherein the central controller comprises means for validating a code for which there is a client record by performing voice verification.

16. A system as claimed in claim 15, wherein the voice verification is performed using the spoken code which is recognised.

17. A system as claimed in claim 15, wherein the system comprises a client-specific stored verification score threshold, above which verification is positive and below which verification is negative.

18. A system as claimed in claim 17, wherein said threshold is set by processing parameter values for a cost of a false accept, a cost of a false accept, and an impostor factor.

19. A system as claimed in claim 18, wherein the controller comprises means for dynamically adjusting the impostor factor according to false accept event data.

20. A system as claimed in claim 13, wherein the central controller comprises means for re-attempting by requesting a fresh spoken code to perform recognition and verification again if the candidate code list is exhausted without identification of a valid client record.

21. A system as claimed in claim 20, wherein the central controller comprises means for re-attempting only a limited number of times.
